(19) United States
(12) Patent Application Publication
(10) Pub. No.: US 2020/0153296 A1
(43) Pub. Date: May 14, 2020

(54) ROTOR UNIT FOR AN ELECTRIC MACHINE

(71) Applicant: Mahle International GmbH, Stuttgart (DE)

(72) Inventors: Gustavo Esteves Albieri, Waiblingen (DE); Karl-Martin Fritsch, Stuttgart (DE); Thorsten Grelle, Stuttgart (DE); Christoph Schmuelling, Leutenbach (DE)

(21) Appl. No.: 16/680,456

(22) Filed: Nov. 11, 2019

(30) Foreign Application Priority Data
Nov. 12, 2018 (DE) 10 2018 219 244.8

(51) Int. Cl. H02K 1/27; H02K 7/04

(52) U.S. Cl. CPC H02K 1/276; H02K 29/03; H02K 7/04

(57) ABSTRACT

A rotor unit for an electric machine may include at least one rotor carrier and a plurality of substantially identical rotor segments. Each of the plurality of rotor segments may include at least one recess through which the rotor carrier is passable. A plurality of axial slot portions may be disposed spaced apart from one another in a circumferential direction along a circumferential contour of the at least one recess. The rotor carrier may include a guide portion that engages in a slot portion of each rotor segment providing a non-rotatable connection therebetween. Via selection of the slot portion of the rotor segment in which the guide portion engages, discrete angular positions of the rotor segment about an axial axis of the rotor carrier may be selectable. The plurality of rotor segments may be arranged in different angular positions about the axial axis of the rotor carrier.

### CROSS-REFERENCE TO RELATED APPLICATIONS

This application claims priority to German Patent Application No. DE 10 2018 219 244.8, filed on Nov. 12, 2018, the contents of which are hereby incorporated by reference in its entirety.

### TECHNICAL FIELD

The present invention relates to a rotor unit for an electric machine and to such an electric machine.

### BACKGROUND

These electric machines, such as for example electric motors and/or generators, include for example direct current machines or synchronous machines, which comprise a stator unit and a rotor unit, which are rotatably mounted relative to one another. In vehicle manufacturing, such electric machines are designed in most cases so that the stator unit generates a magnetic field that varies over time, which acts on the rotor unit that is equipped with permanent magnets. By way of this, the electric energy, which is fed to the stator unit, can be converted into mechanical rotary motion of the rotor unit. For this purpose, the stator unit can comprise electrical line windings or coils which are suitably energised via a control device in order to generate a magnetic field that varies over time. It can also be provided that the rotor unit is mechanically driven and generates a magnetic field that varies over time, which induces an electric current flow in the stator unit. Such permanent magnet-excited machines are employed in large numbers in vehicle manufacturing and can be designed for example as actuating motors.

From the prior art it is known that by way of an interaction of the magnetic field of the stator unit and of the magnetic field of the rotor unit undesirable magnetic interference fields can form. These interference fields lead to cogging torques which act on the rotor unit and result in irregular rotary motion of the rotor unit and in a shorter lifespan of the electric machine. The development of these cogging torques can be counteracted by a so-called skewing of the rotor unit, in which the rotor unit comprises multiple rotor segments which are arranged on a rotor carrier with an axial axis, wherein the rotor segments are each orientated twisted about the axial axis relative to one another or have an angular offset.

From DE 10 2017 102 242 A1 a rotor unit having a skew is known, wherein the respective rotor segment has a recess for passing through the rotor carrier. The recess can comprise two connecting portions that are arranged diametrically relative to one another, each of which can engage in a wedge slot of the rotor carrier. By way of such a configuration of the rotor carrier, forming a skew of the rotor unit is only possible when different rotor segments are employed, in which in each case the position of the connecting portions varies in the circumferential direction relative to the position of the permanent magnets. Such a configuration is cost-intensive since the respective rotor segments have to be formed differently and require separate manufacturing tools or need a re-programming of the manufacturing tools.

DE 10 2015 007 138 A1 proposes that identical rotor segments are employed, wherein the rotor segments in the circumferential direction have a multiplicity of elongated holes, wherein corresponding elongated holes of multiple rotor segments form an axial recess into which in each case a screw element is introduced in order to connect the rotor segments to one another and to the rotor carrier. With this configuration, the rotor segments can be continuously twisted relative to one another in the region of the dimensions of the elongated hole so that a skew of the rotor unit is adjustable. Disadvantageous in this configuration is that a multiplicity of screw elements is required which do not have any electromagnetic purpose within the electric machine and increase the weight of the electric machine. In addition, the distribution of the screw elements influences the moment of inertia of the rotor unit. Furthermore, the screw elements result in increased production costs. A further disadvantage of such a configuration with elongated holes is that the twisting of the individual rotor segments relative to one another takes place continuously and requires a corresponding monitoring or regulating in order to achieve a desired twisting between rotor segments.

DE 10 2010 044 521 A1 and DE 10 2008 020 778 A1 provide rotor segments which in the circumferential direction have a multiplicity of elongated holes. The disadvantages mentioned above are also incurred here.

EP 2 451 049 A1 proposes that a rotor segment can be formed from multiple identical rotor layers in order to for example reduce eddy current losses, wherein the respective rotor segments are formed differently in order to achieve a skew of the rotor unit. Here it is provided that the individual rotor layers have bores, into which screw bolts can be introduced in order to hold the respective rotor segment together. The respective rotor segment comprises a recess for passing through the rotor carrier, wherein the recess comprises three tongues which are each offset by 120° in the circumferential direction of the recess, each of which can engage in a corresponding slot of the rotor carrier. Such a configuration results in the disadvantages already mentioned above.

DE 10 2008 020 779 A1 provides rotor segments which in the circumferential direction have a multiplicity of elongated holes, wherein the elongated holes can have a contour that is designed so that a fastening means is moveable within the elongated hole not continuously but in steps or discretely. By way of this, twisting the rotor segments by a certain angle is simplified, wherein however the abovementioned disadvantages continue to be present which are created in that additional screw elements have to be passed through the elongated holes.

DE 195 43 919 C1 provides a method with which rotor segments are rigidly connected to the rotor carrier within the scope of a plastic injection moulding operation. Here, the use of the plastic injection moulding operation which increases the production costs of the rotor unit is disadvantageous.

### SUMMARY

The present invention is based on the object of stating a rotor unit of the type mentioned at the outset which can be produced in a simpler and more cost-effective manner.

According to the invention, this problem is solved through the subjects of the independent claim(s). Advantageous embodiments are subject of the dependent claim(s).

The present invention is based on the general idea that substantially identical rotor segments are employed, wherein by way of slot portions of the rotor segments discrete angular positions of the respective rotor segment about an axial axis of the rotor carrier is/are selectable in order to form a skew of the rotor unit.

The rotor unit according to the invention for an electric machine, which is preferably an electric motor, provides at least one rotor carrier and multiple rotor segments that are substantially identical. The rotor carrier can be formed for example as hollow shaft and/or solid shaft, wherein the rotor carrier can also comprise corresponding bearing units.

The term identical is to mean that the rotor segments, within the manufacturing tolerances, substantially have the same geometrical configurations. Thus it is possible that all rotor segments required for the rotor unit can be produced with a single tool configuration in order to reduce the production costs of the rotor unit or of the electric machine.

A rotor segment can comprise multiple substantially identical rotor layers, between which electrically insulating layers can be provided in order to minimise eddy current losses. Electrically insulating layers can also be provided between the rotor segments.

The rotor segment comprises at least one recess for passing through the rotor carrier, wherein in the circumferential direction along a circumferential contour of the recess, axial slot portions that are spaced apart relative to one another are provided, the number of which corresponds at least to the number of the rotor segments. An axial slot portion can be formed complementarily to the guide portion, in order to form a positive-locking connection. The axial slot portion can comprise an axially extending slot.

The rotor carrier comprises a guide portion which engages in a slot portion of each rotor segment in order to form a non-rotatable connection between the rotor carrier and this rotor segment. By selecting the slot portion of a rotor segment, in which the guide portion engages, discrete angular positions of the rotor segments about an axial axis of the rotor carrier are selectable. Here it is provided that the rotor segments are arranged in different angular positions about the axial axis of the rotor carrier. A discrete angular position can be achieved in that the guide portion and the respective slot portion are formed within the manufacturing tolerances so that between the respective slot portion and the guide portion a detachable connection can be established, wherein the play between the respective slot portion and the guide portion is minimised within the manufacturing tolerances. Here it can be provided that the manufacturing tolerances are selected so that the rotor segments can be positioned on the rotor carrier at room temperature, i.e. for example in the temperature range from 0° C. to 30° C.

Forming a desired skew of the rotor unit is explained by way of the following example. An exemplary rotor unit comprises five rotor segments so that each rotor segment comprises five slot portions. The guide portion of the rotor carrier engages in the first rotor segment in the first slot portion, in the second rotor segment in the second slot portion, in the third rotor segment in the third slot portion, in the fourth rotor segment in the fourth slot portion and in the fifth rotor segment in the fifth slot portion. Thus, the guide portion for each rotor segment merely engages in one of the five slot portions. Because of this, the identically formed rotor segments have different angular positions about the axial axis of the rotor carrier and form a desired skew of the rotor unit. Here, the selection of the angular position of the rotor segment relative to the rotor carrier takes place discretely and not continuously. This example can be expanded to any number of N rotor segments each with N slot portions.

By way of such a configuration of the rotor segments, the use of elongated holes with corresponding connecting elements can be omitted, so that the production of the rotor unit is simplified, wherein in addition the total weight and the production costs of the electric machine are reduced.

In a further advantageous embodiment of the solution according to the invention it is provided that two directly adjacent rotor segments each have a substantially identical part angular offset about the axial axis of the rotor carrier relative to one another. Two rotor segments are directly adjacent when their face ends are located opposite one another.

A design of a desired skew of the rotor unit is explained by way of the following example. An exemplary rotor unit comprises five rotor segments, in which between the first rotor segment and the second rotor segment a part angular offset about the axial axis of the rotor carrier is provided. Between the second rotor segment and the third rotor segment, between the third rotor segment and the fourth rotor segment, between the fourth rotor segment and the fifth rotor segment a part angular offset about the axial axis of the rotor carrier each is provided, wherein the part angular offset between all directly adjacent rotor segments is identical within the scope of the manufacturing tolerances.

In an advantageous further development of the solution according to the invention it is provided that a first rotor segment is provided, which only has a directly adjacent rotor segment, that a last rotor segment is provided, which comprises only one directly adjacent rotor segment and is spaced apart from the first rotor segment, wherein between the first rotor segment and the last rotor segment an angular offset is present which is a multiple of the part angular offset. Since the part angular offset between all directly adjacent rotor segments is identical, an even skew of the rotor unit is formed, which leads to a quieter running behaviour of the rotor unit and to a longer lifespan of the electric machine.

In a further advantageous embodiment of the solution according to the invention it is provided that the rotor unit for an electric machine is formed with a stator unit having SN stator slots, wherein the angular offset substantially corresponds to 360°/SN. Such a configuration counteracts the development of cogging torques particularly favourably.

In an advantageous further development of the solution according to the invention it is provided that N rotor segments are provided, wherein each rotor segment P forms magnetic pole pairs. The pole pairs can be formed for example through suitable permanent magnets inserted and/or buried in into the rotor segment. The rotor unit is designed for an electric machine having a stator unit with SN stator slots, wherein a rotor segment has K slot portions, wherein K≥N applies. Since only discrete angular positions of the rotor segments about the axial axis of the rotor carrier are possible, at least K=N has to be selected in order to achieve an even skew of the rotor unit. With k=1 to K, the k-th slot portion is referenced, wherein the slot portion with k=1 forms a reference point on the circumferential contour of the recess of the rotor segment. Since the rotor segments are substantially formed identical, each rotor segment has corresponding slot portions k=1 to K. The angular interval W(k) with a given direction of rotation between the reference point and the k-th slot portion is formed according to

W(k)=[(k−1)*360°*{1/(SN*N)+1/P}] mod 360°.

The direction of rotation can also be fixed in clockwise or counter clockwise direction, wherein following a fixing of the direction of rotation the same has to be maintained. The angular interval W(k) describes the position of the k-th slot portion in the circumferential direction along a circumferential contour of the recess of the rotor segment relative to the reference point.

The angular difference WD with a given direction of rotation between the k+1-th slot portion and the k-th slot portion amounts to WD=360°*{1/(SN*N)+1/P}. It can be provided that the sum angular differences WD is not a multiple of 360°.

In a further advantageous embodiment of the solution according to the invention it is provided that N=5 rotor segments are provided, wherein each rotor segment forms P=4 magnetic pole pairs, wherein the rotor unit is designed for an electric machine having a stator unit with SN=48 stator slots, wherein a rotor segment comprises K≥5 slot portions, wherein k=1 to K references the k-th slot portion, wherein the slot portion with k=1 forms a reference point on the circumferential contour of the recess of the rotor segment, wherein the angular difference WD with a given direction of rotation between the k+1-th slot portion and the k-th slot portion is

WD=360°*{1/(SN*N)+1/P}=91.5°.

Such a configuration of the rotor unit according to the invention offers a wide range of application within the vehicle manufacturing so that electric machines with such rotor units can be manufactured and employed in large numbers.

In an advantageous further development of the solution according to the invention it is provided that each rotor segment comprises a plurality of substantially identical rotor layers in order to reduce eddy current losses.

In a further advantageous embodiment of the solution according to the invention it is provided that each rotor segment comprises pocket regions for receiving magnet elements. The pocket regions, which can be employed for forming a magnetic pole of the rotor segment, can be formed for example v-shaped and/or double-v-shaped.

In an advantageous further development of the solution according to the invention it is provided that the guide portion has a longitudinal slot on the rotor carrier into which a dowel pin element is introduced, which engages in the respective slot portion of a rotor segment. The dowel element can substantially correspond to the length of the longitudinal slot, wherein multiple dowel pin elements are also conceivable which substantially correspond to the length of a rotor segment. By using dowel pin elements, the guide portion can be easily and cost-effectively produced.

Furthermore, the invention relates to an electric machine having a stator unit with stator slots, wherein a rotor unit according to the invention is provided, wherein the rotor unit and the stator unit are rotatably mounted relative to one another.

The electric machine can be for example designed as direct current machine or as synchronous machine. It can be provided that the stator unit generates a magnetic field that varies over time, which acts on the rotor unit, which is equipped with permanent magnets. By way of this, electric energy, which is fed to the stator unit, can be converted into a mechanical rotary motion of the rotor unit. For this purpose, the stator unit can comprise electric line windings or coils, which are suitably energised via a control device in order to generate a magnetic field that varies over time. It can also be provided that the rotor unit is mechanically driven and generates a magnetic field that varies over time, which induces an electric current flow in the stator unit.

Further important features and advantages of the invention are obtained from the subclaims, from the drawings and from the associated figure description by way of the drawings.

It is to be understood that the features mentioned above and still to be explained in the following cannot only be used in the following combination stated but also in other combinations or by themselves without leaving the scope of the present invention.

Preferred exemplary embodiments of the invention are shown in the drawings and are explained in more detail in the following description, wherein same reference numbers relate to same or similar or functionally same components.

### BRIEF DESCRIPTION OF THE DRAWINGS

There it shows, in each case schematically,

FIG. 1 shows a perspective view of a rotor unit according to the invention,

FIG. 2 shows a lateral view of the rotor unit from FIG. 1,

FIG. 3 shows a perspective view of a rotor carrier according to the invention and of a rotor segment according to the invention,

FIG. 4 shows a perspective view of a rotor carrier according to the invention with arranged rotor segments,

FIG. 5 shows a view of a face end of a rotor segment according to the invention,

FIG. 6 shows a view of a face end of an electric machine according to the invention.

### DETAILED DESCRIPTION

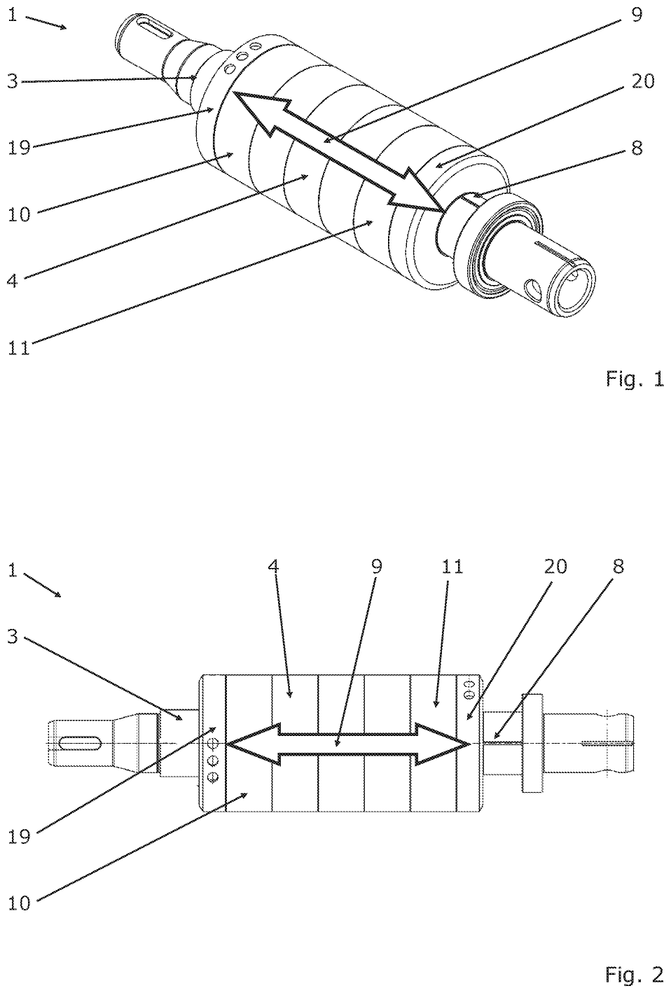

In FIG. 1, a perspective view of a rotor unit 1 according to the invention is shown, wherein the rotor unit 1 comprises five substantially identical rotor segments 4, which are arranged on a rotor carrier 3. To this end, the rotor segments 4 each have at least one recess 5 for passing through the rotor carrier 3. In FIG. 2, a lateral view of the rotor unit 1 from FIG. 1 is shown.

The rotor carrier 3 is at least partly formed as hollow shaft and comprises an axial axis 9 which is substantially orientated parallel to the longitudinal extension of the rotor carrier 3. The rotor segments 4 are arranged along this axial axis 9, wherein on a first rotor segment 10 a first balancing disc 19 and on a last rotor segment 11 a second balancing disc 20 are provided. The first balancing disc 19 and the second balancing disc 29 can be employed for offsetting an imbalance of the rotor unit 1.

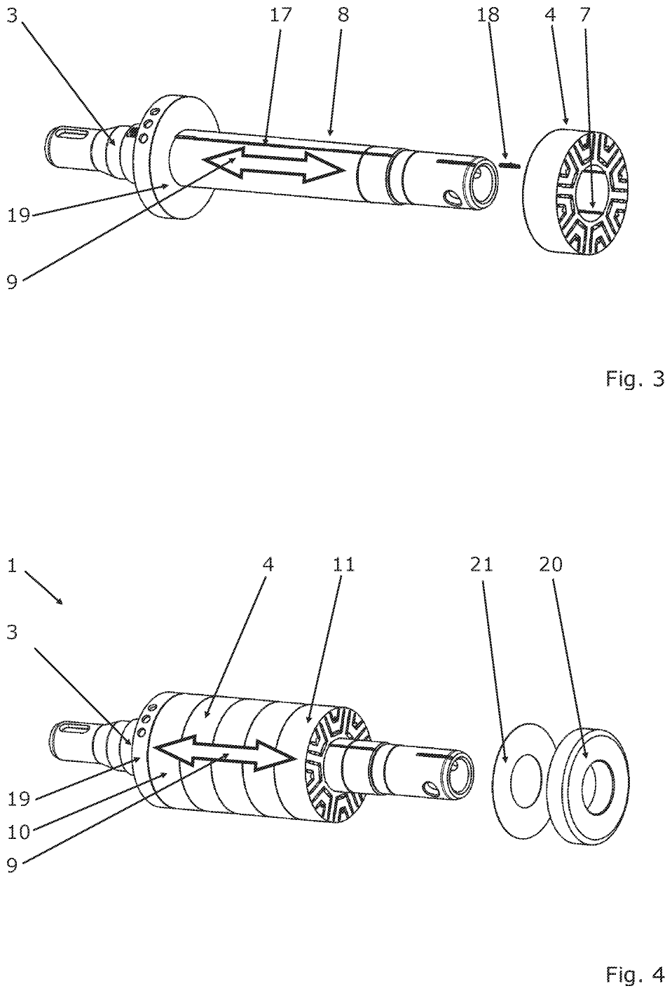

Between the rotor segments 4 and the rotor carrier 3, a non-rotatable connection is established, in that a guide portion 8 engages in a slot portion 7 of the respective rotor segment 4. As is shown in FIG. 3 and FIG. 4, the guide portion 8 can comprise a longitudinal slot 17 which extends at least partly along an outer surface of the rotor carrier 3, wherein in this longitudinal slot 17 a dowel pin element 18 can be inserted which forms a positive-locking connection between the longitudinal slot 17 and the corresponding slot portion 7 of the rotor segment 4. As in FIG. 3, the dowel pin element 18 can have a length which substantially corresponds to the length of the rotor segment 4.

Between the individual rotor segments 4 and also between the first rotor segment 10 and the first balancing disc 19 as well as between the last rotor segment 11 and the second balancing disc 20, an insulator disc 21 each can be provided, which can be formed from a substantially electrically insulating material.

By way of the selection of the slot portion 7 of a rotor segment 4, in which the guide portion 8 engages, discrete angular positions of the rotor segment 4 about the axial axis 9 of the rotor carrier 3 can be selected, wherein the rotor segments 4 are arranged in different angular positions about the axial axis 9 of the rotor carrier 3 in order to achieve a skew of the rotor unit 1.

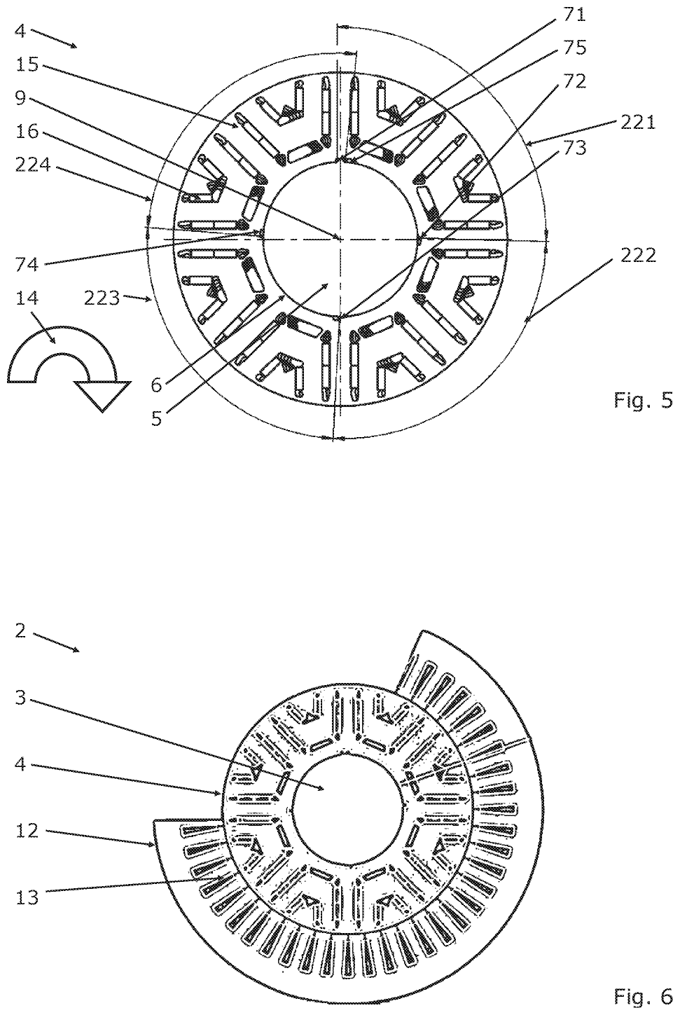

In FIG. 5, a view of a face end of a rotor segment 4 according to the invention is shown. The face end of the rotor segment 4 has an annular disc-shaped contour. The rotor segment 4 comprises a multiplicity of pocket regions 15 for receiving magnet elements 16. In this exemplary embodiment, the magnet elements 16 are arranged double-V-like, so that four pole pairs are formed.

In an installation position of the rotor segment 4, which is shown in the FIGS. 1 to 4, the axial axis 9 of the rotor carrier 3 substantially penetrates the centroid of an area of the recess 5. In FIG. 5, the axial axis 9 extends parallel to the normal vector of the drawing plane. The recess 5 has a circumferential contour 6 which provides five slot portions since the rotor unit 1 in this exemplary embodiment comprises five rotor segments 4.

The first slot portion 71 in this exemplary embodiment forms a reference point and the direction of rotation 14 in the following consideration is always fixed in the clockwise direction. Between the first slot portion 71 and a second slot portion 72, an angular difference 221 along the circumferential contour 6 is provided. Between the second slot portion 72 and a third slot portion 73 an angular difference 222 along the circumferential contour 6 is provided. Between the third slot portion 73 and a fourth slot portion 75 an angular difference 223 along the circumferential contour 6 is provided. Between the fourth slot portion 74 and a fifth slot portion 75 an angular difference 224 along the circumferential contour 6 is provided. The angular differences 221, 222, 223, 224 substantially have the same angular difference value, wherein in this embodiment the angular difference value corresponds to 91.5°. In this exemplary embodiment, the sum of the angular differences corresponds to 366° and is thus not a multiple of 360°.

The angular interval of the second slot portion 72 relative to the reference point (first slot portion 71) is 91.5° along the circumferential contour 6 according to the direction of rotation 14. The angular interval of the third slot portion 73 relative to the reference point (first slot portion 71) is 183° along the circumferential contour 6 according to the direction of rotation 14. The angular interval of the fourth slot portion 74 relative to the reference point (first slot portion 71) is 274.5° along the circumferential contour 6 according to the direction of rotation 14. The angular interval of the fifth slot portion 75 relative to the reference point (first slot portion 71) is 6° along the circumferential contour 6 according to the direction of rotation 14.

In FIG. 6, a front view of an electric machine 2 according to the invention is shown. The electric machine 2 comprises a stator unit 12 with stator slots 13, wherein only one part segment of the stator unit 12 is shown. The rotor unit 1 according to the invention or each rotor segment 4 is mounted so that a relative rotary motion with respect to the stator unit 12 can be performed.

1. A rotor unit for an electric machine, comprising:
at least one rotor carrier;
a plurality of substantially identical rotor segments;
each of the plurality of rotor segments including at least one recess through which the rotor carrier is passable;
a plurality of axial slot portions disposed spaced apart from one another in a circumferential direction along a circumferential contour of the at least one recess, a number of the plurality of axial slot portions corresponding at least to a number of the plurality of rotor segments;
the rotor carrier including a guide portion that engages in a slot portion of the plurality of axial slot portions of each rotor segment of the plurality of rotor segments providing a non-rotatable connection between the rotor carrier and the rotor segment;
wherein, via selection of the slot portion of the rotor segment in which the guide portion engages, discrete angular positions of the rotor segment about an axial axis of the rotor carrier are selectable; and
wherein the plurality of rotor segments are arranged in different angular positions about the axial axis of the rotor carrier.

2. The rotor unit according to claim 1, wherein a part angular offset about the axial axis of the rotor carrier is provided between two directly adjacent rotor segments of the plurality of rotor segments, and wherein the part angular offset between each pair of directly adjacent rotor segments a substantially identical.

3. The rotor unit according to claim 2, wherein:
the plurality of rotor segments includes a first rotor segment that is disposed directly adjacent to only one other rotor segment of the plurality of rotor segments;
the plurality of rotor segments includes a last rotor segment that is disposed directly adjacent to only one other rotor segment of the plurality of rotor segments and is disposed spaced apart from the first rotor segment; and
wherein an angular offset between the first rotor segment and the last rotor segment is a multiple of the part angular offset.

4. The rotor unit according to claim 3, wherein:
the rotor unit is configured for an electric machine having a stator unit with SN stator slots; and
the angular offset substantially corresponds to 360°/SN.

5. The rotor unit according to claim 1, wherein:
the plurality of rotor segments includes N rotor segments;
each rotor segment of the plurality of rotor segments forms P magnetic pole pairs;
the rotor unit is configured for an electric machine having a stator unit with SN stator slots;
the plurality of axial slot portions includes K slot portions, where K≥N;
k=1 to K references a k-th slot portion of the plurality of axial slot portions;
a slot portion of the plurality of axial slot portions with k=1 defines a reference point on the circumferential contour of the at least one recess; and
an angular interval W(k) with a given direction of rotation between the reference point and the k-th slot portion is formed according to
W(k)=[(k−1)*360°*{1/(SN*N)+1/P}] mod 360°.

6. The rotor unit according to any one of the preceding claims, claim 1, wherein:
the plurality of rotor segments includes N=5 rotor segments;
each rotor segment of the plurality of rotor segments forms P=4 magnetic pole pairs,
the rotor unit is configured for an electric machine having a stator unit with SN=48 stator slots;
the plurality of axial slot portions includes K≥5 slot portions;
k=1 to K references a k-th slot portion of the plurality of axial slot portions;
a slot portion of the plurality of axial slot portions with k=1 defines a reference point on the circumferential contour of the at least one recess; and
an angular difference WD with a given direction of rotation between a k+1-th slot portion of the plurality of axial slot portions and the k-th slot portion is
WD=360°*{1/(SN*N)+1/P}=91.5°.

7. The rotor unit according claim 1, wherein each rotor segment of the plurality of rotor segments includes a plurality of substantially identical rotor layers.

8. The rotor unit according to claim 1, wherein each rotor segment of the plurality of rotor segments includes a plurality of pocket regions structured and arranged to receive magnet elements.

9. The rotor unit according to claim 1, wherein:
the guide portion includes a longitudinal slot and
a dowel pin element is arranged in the longitudinal slot and engages in one of the plurality of axial slot portions of a respective rotor segment of the plurality of rotor segments.

10. An electric machine, comprising:
a stator unit including a plurality of stator slots;
a rotor unit;
the rotor unit and the stator unit mounted rotatably relative to one another;
the rotor unit including:
at least one rotor carrier;
a plurality of substantially identical rotor segments;
each of the plurality of rotor segments including at least one recess through which the rotor carrier is passable;
a plurality of axial slot portions disposed spaced apart from one another in a circumferential direction along a circumferential contour of the at least one recess, a number of the plurality of axial slot portions corresponding at least to a number of the plurality of rotor segments;
the rotor carrier including a guide portion that engages in a slot portion of the plurality of axial slot portions of each rotor segment of the plurality of rotor segments providing a non-rotatable connection between the rotor carrier and the rotor segment;
wherein, via selection of the slot portion of the rotor segment in which the guide portion engages, discrete angular positions of the rotor segment about an axial axis of the rotor carrier are selectable; and
wherein the plurality of rotor segments are arranged in different angular positions about the axial axis of the rotor carrier.

11. The rotor unit according to claim 1, further comprising a plurality of insulator discs composed of an electrically insulating material.

12. The rotor unit according to claim 11, wherein an insulator disc of the plurality of insulator discs is disposed between each pair of directly adjacent rotor segments of the plurality of rotor segments.

13. The rotor unit according to claim 1, further comprising a first balancing disc, wherein:
the plurality of rotor segments includes a first rotor segment that is disposed directly adjacent to only one other rotor segment of the plurality of rotor segments;
the plurality of rotor segments includes a last rotor segment that is disposed directly adjacent to only one other rotor segment of the plurality of rotor segments and is disposed spaced apart from the first rotor segment; and
the first balancing disc is disposed on a side of the first rotor segment opposite the other rotor segments of the plurality of rotor segments.

14. The rotor unit according to claim 13, further comprising a second balancing disc disposed on a side of the last rotor segment opposite the other rotor segments of the plurality of rotor segments such that the plurality of rotor segments are disposed axially between the first balancing disc and the second balancing disc relative to the axial axis, wherein the first balancing disc and the second balancing disc offset an imbalance of the rotor unit.

15. The rotor unit according to claim 14, further comprising a plurality of insulator discs composed of an electrically insulating material, wherein a first insulator disc of the plurality of insulator discs is disposed between the first rotor segment and the first balancing disc, and wherein a second insulator disc of the plurality of insulator discs is disposed between the last rotor segment and the second balancing disc.

16. The rotor unit according to claim 8, wherein the plurality of pocket regions are disposed in a respective axial face of the plurality of rotor segments.

17. The rotor unit according to claim 16, wherein the plurality of pocket regions include a plurality of substantially V-shaped pocket regions, and wherein the plurality of V-shaped pocket regions respectively include a vertex oriented toward the axial axis.

18. The rotor unit according to claim 17, wherein at least two of the plurality of V-shaped pocket regions are arranged and oriented in radial alignment with one another relative to the axial axis.

19. The rotor unit according to claim 9, wherein an axial length of the dowel pin element relative to the axial axis substantially corresponds to an axial length of the respective rotor segment.

20. A rotor unit for an electric machine, comprising:
at least one rotor carrier;
a plurality of substantially identical rotor segments;
each of the plurality of rotor segments including a plurality of pocket regions and at least one axial recess through which the rotor carrier is passable;
a plurality of magnets arranged within the plurality of pocket regions;
a plurality of axial slot portions disposed spaced apart from one another in a circumferential direction along a circumferential contour of the at least one recess, a number of the plurality of axial slot portions corresponding at least to a number of the plurality of rotor segments;
the rotor carrier including a guide portion that engages in a slot portion of the plurality of axial slot portions of each rotor segment of the plurality of rotor segments providing a non-rotatable connection between the rotor carrier and the rotor segment;
wherein, via selection of the slot portion of the rotor segment in which the guide portion engages, discrete angular positions of the rotor segment about an axial axis of the rotor carrier are selectable; and
wherein the plurality of rotor segments are arranged in different angular positions about the axial axis of the rotor carrier.
